(19) United States
(12) Patent Application Publication
(10) Pub. No.: US 2007/0005431 A1
(43) Pub. Date: Jan. 4, 2007

(54) System of providing message content in a communication system ring-back space

(76) Inventor: Nick Arauz, Brooklyn, NY (US)

Correspondence Address: Barry E. Negrin;Levisohn, Berger & Langsam, LLP, 19th Floor, 805 Third Avenue, New York, NY, 10022, US

(21) Appl. No.: 11/475,493

(22) Filed: Jun. 27, 2006

Related U.S. Application Data
(63) Continuation-in-part of application No. 11/198,341, filed on Aug. 6, 2005.
(60) Provisional application No. 60/696,447, filed on Jul. 1, 2005.

(51) Int. Cl. G06Q 30/00

(52) U.S. Cl. 705/14

(57) ABSTRACT

A system of selectively providing message content in a communication system ring-back space is provided. A message database is accessible by one or more message creators and stores one or more messages adapted to be playable in place of a communication system ring-back tone. An endorser database is accessible by a plurality of endorsers having communication service and stores a plurality of endorser profiles. Each of the endorser profiles includes endorser-selectable variables for selecting at least one of the messages to be played in place of the respective endorsers' ring-back tone. An endorsement routing interface, in communication with the message database and the endorser database, routes the messages from the message database to the endorsers' communication service providers for playback in place of the endorsers' ring-back tone in accordance with the endorser profiles. The endorser is compensated for each playback of the message in the endorser's ring-back space.

### REFERENCE TO RELATED APPLICATIONS

This is a continuation-in-part of U.S. patent application Ser. No. 11/198,341 filed Aug. 6, 2005 and claims domestic priority therefrom and from U.S. Provisional Patent Application No. 60/696,447 filed Jul. 1, 2005, the entire contents of both of which are incorporated by reference herein.

### BACKGROUND OF THE INVENTION

1. Field of the Invention

The present invention relates to a system of replacing ring-back tones with other content, and more specifically to a system for matching message creators and potential endorsers for the purchase of an endorsed message transmission between associated individuals.

2. Description of the Related Art

Users of cell phones, telephones, and other communication devices are frequently looking for new accessories and services to use with their devices. For example, a big business has sprung up in the sale of ring tones, the sound a communication device makes to signal its owner that a transmission (be it text, audio, video, or the like) is incoming.

Another aspect of telecommunication services that has recently become customizable is the ring-back tone, the “ringing” sound generated for the benefit of the caller to let the caller know that the call has been connected and is ringing at the receiver's end. Current systems for customizing the ring back tone includes the user paying a fee for putting alternate content into the ring-back tone space.

Another constant in telecommunication services (or any service, for that matter) is that consumers frequently desire lower service rates, discounts, or rebates for service. Rebates are commonly offered when consumers purchase new devices, and call plans typically offer less expensive per-minute rates when minutes are purchased in larger and larger quantities. However, there has yet to be a system or device that enables the telecommunication user to benefit financially the more she receives calls or messages.

Wholly unrelatedly, marketing is used for a variety of purposes, such as commercial advertising, political advertising, cause and appeal marketing, or simply for the purpose of spreading non-commercial content. Traditionally, marketing campaigns are implemented by placing the marketing content adjacent to non-marketing content, such as the placement of a television advertisement or a magazine advertisement. For a campaign to be effective marketers rely on the popularity of the complimentary non-marketing content; therefore, the cost of different placements varies depending on the size of the audience for the non-marketing content. For instance, the cost of advertising during popular television programs is often higher than the cost of advertising on unpopular programs. In addition, qualities of the audience are also taken into consideration. For instance, the cost of placing an advertisement during a popular television program is likely to be further inflated if the audience can be shown to have a high level of expendable income. Marketing in these ways has some inherent disadvantages. First, the cost of such marketing is high, since the revenue generated by the advertisements is relied upon for the development of the complimentary non-marketing content. In addition, the public has been shown to perceive these methods as intrusive to the non-marketing content, and so means have been devised to help consumers exclude marketers' content from broadcast media such as television and radio, such as commercial-free “premium” television stations, digital video recorders (e.g., TiVo), and satellite radio.

Direct marketing relies on smaller, more deliberately targeted messages, using either direct mail, the telephone (telemarketing), direct email, or a variety of direct marketing methods on the internet (e.g., banner advertising, pop-up advertising, search engine advertising, etc.). Direct marketing was devised to allow a broader range of marketers to reach specific individuals who could be identified through publicly or privately disclosed demographic or psychographic data generally known about the individuals (e.g. mailing address, telephone number, age, shopping habits, web browsing habits, etc.). Direct marketing also has several disadvantages: First, the sheer volume of competing marketing messages that exist in these media make it difficult for a single marketer's message to be acknowledged. Second, these media are also usually perceived as intrusive to the person receiving the advertisement (e.g., no one looks forward to a pop-up ad while browsing the Internet). Third, because of this negative perception, direct marketing methods such as telemarketing and direct email are being deliberately blocked by state and federal legislation.

Considering these issues, marketers have focused on finding ways to make their messages more trusted, more likely to be heard, and more relevant to the receiver (the person who ultimately receives the marketer's message). One such way is to have their offering endorsed by trustworthy or influential individuals, and to encourage these individuals to communicate with others about the benefits of the marketer's products and services. A common and long-standing manifestation of this concept is celebrity endorsement, where a marketer will pay a well-known individual to endorse a specific product, and to either record the endorsement explicitly or to embed the endorsement in media other ways (e.g., product placement in a movie or logo placement on sporting uniforms). Marketers may then use mass media to broadcast or distribute the endorsement to the public. Advertising in this manner is commonplace, but is impractical for marketers with limited resources, who are unable to pay the normal (exorbitant) fees associated with both the celebrity endorser and the mass media. Furthermore, it is commonly recognized that a significant portion of the expense of celebrity endorsement and the associated distribution method is wasted, due to the fact that not all such endorsements are acknowledged by the audience or subscriber base of the medium (for the reasons listed above), and normally only a portion of the audience that acknowledges the endorsement considers the endorser to be a reliable and trusted endorser.

Another marketing scheme is sometimes known as peer-to-peer marketing (or experience marketing or viral marketing), where the marketer sponsors and/or creates a novel experience for a targeted first-tier audience, and relies on the novelty of the experience to trigger a chain reaction in which the first-tier audience is compelled to tell their friends and other associates about the experience, and to encourage those friends and associates to continue to tell others. Experience marketing is more broadly affordable than celebrity endorsement, since the scale of the experience may range from a very small experience (e.g., a street performance, poster, graffiti, or the speaking of a brand name in an exclusive venue), to a larger experience (e.g. experiences within retail stores, sporting event sponsorship, films, entertainment events). Peer-to-peer marketing is also considered to have some advantages over conventional advertising methods, because the marketer is establishing a relationship with an individual, who, in reaction to a positive experience provided by the marketer, is compelled to work on behalf of the marketer to endorse the marketer's offering directly to a “second tier”: the individual's friends and associates. When successful, this method is recognized to have two advantages over conventional advertising: First, each one of the first-tier audience may be compelled to tell several other people (a second tier audience), who in turn may tell others (a third tier, and so on), and so the marketer can reach an extended audience with a single initiative or campaign. Second, the pre-existing relationship that the first-tier individuals have with the second tier individuals give the individuals a degree of credibility and trust, which benefits the marketer. However, in common practice, peer-to-peer marketing has a major disadvantage: the marketer has no agreement with the individual endorser, and therefore has very little control over what actual message is transmitted by the individual, or means by which to verify if any positive message was transmitted about the experience.

A computer-based advertising system called Attention Brokerage is described in U.S. Pat. No. 5,794,210 to Goldhaber, et al. The Goldhaber invention describes a marketing system of “Attention Brokerage” and “Orthogonal Sponsorship”, in which the receiver of the advertisement is compensated for their attention to, and interaction with, advertising content broadcast on the internet, and in which the compensation may include coupons or other ‘negatively priced content’ that the receiver of the advertisement can spend on purchases online. This attempts to make the marketing content directly relevant to the receiver of the marketing content by compensating the receiver for their attention. While novel in comparison to other forms of marketing discussed above, this invention has a major disadvantage in that it requires interaction between the receiver of the marketing content and the content itself, for each placement, such as actions taken (e.g., “clicks” on a web-based ad) on behalf of the receiver with the use of a personal computer, in order to prove that the attention of the receiver was given, so that compensation can be made accordingly. The value of the receiver's time and attention is underestimated in the Goldhaber invention; in practice, it is difficult to compensate receivers fairly for such use of their time. Furthermore, because the non-marketing content for the Goldhaber invention is envisioned as content that the receiver has specifically requested through the internet or other means, the marketing content adjacent to this non-marketing content is more likely to be ignored or regarded as intrusive regardless of the compensation. Furthermore, there is no explicit mechanism to compel the receiver to pass on the marketer's message to a second-tier audience, and no compensation to the receiver for any further endorsement, as in celebrity endorsement arrangements.

U.S. Pat. No. 5,438,356 to Ushiki, et al. describes an accounting system for multimedia communication systems in which third-party content, such as advertising, may be embedded in transmissions between two terminals within a multimedia communications system such as a broadband telephone system. The marketer, in the Ushiki invention, sponsors individual communication links between users, thereby reducing the cost of the service to the end user, in return for marketing content to be transmitted with the same communication link. As above, the marketing content in the Ushiki invention is transmitted during non-marketing content, namely the time that the two communication terminals are communicating. This is a major disadvantage to marketers, because once again, like the Goldhaber invention, the marketing content is competing with more relevant non-marketing content, namely the communication itself. In addition, the Ushiki invention fails to integrate a mechanism wherein the supplier of the content (the marketer) can make advance arrangement with the user of either terminal for the endorsement of the content. Therefore, the embedded content is less likely to be perceived by the receiver as trustworthy, authentic, and/or relevant to the receiver(s).

Based on the examples above, there remains a strong need among marketers for more effective ways to make their messages more trusted, authentic, more likely to be acknowledged, and more relevant to the receiver. Similarly, although heretofore wholly unrelatedly, there remains a strong need to provide customizable content in the ring-back space of a telecommunications user.

### SUMMARY OF THE INVENTION

The above and other previously disparate needs are met by the invention, which is a system of selectively providing message content in a communication system ring-back space. The messages are usually audio messages but may include a visual component for playback on the screens of a caller's communication device. The system includes a message database, accessible by one or more message creators, on which are stored one or more messages adapted to be playable in place of a communication system ring-back tone. An endorser database, accessible by a plurality of endorsers having telephone service, stores a plurality of endorser profiles. Each of the endorser profiles include endorser-selectable variables for selecting at least one of the messages to be played in place of the respective endorsers' ring-back tone. An endorsement routing interface is in communication with the message database, the endorser database, and the endorsers' telecommunication service providers, routing the messages from the message database to the communication service providers for playback in place of the endorsers' ring-back tone in accordance with the endorser profiles.

The endorser profiles may further include endorser identification variables for placing each endorser into one or more demographic subsets of the endorsers. These variables may include such demographic data as age, location, lifestyle, or communication service provider.

The inventive system preferably also includes message profiles, stored on the message database, which include message creator-selectable instructions for enabling playback of the messages in place of the ring-back tones of at least one of the demographic subsets of the endorsers determinable by the endorser identification variables.

Another preferable feature of the inventive system is a message creator interface that allows access to the message database by the message creators. The message creator interface may be a web-based GUI, and it may include playback limiting variables for limiting the transmission of the messages. The playback limiting variables may include maximum number of message playbacks, frequency of message playbacks, or cutoff date of message playback.

Similarly, the inventive system may preferably include an endorser interface allowing construction of and access to the endorser profiles by the endorsers. The endorser interface may be a web-based GUI and may include a search engine that allows the endorser to select which of the messages to play back in place of the endorser's ring-back tone. The endorser interface may preferably also include a new endorser interface for allowing individuals with telephone service to enroll as endorsers. The new endorser interface may also be a web-based GUI.

As the inventive system has, as one of its features, the ability to compensate the endorsers for each message played on their respective ring-back space, a transaction database is preferably provided in communication with the communication service providers for storing information concerning the successful playback of the messages in place of the endorsers' ring-back tones. A billing module in communication with the transaction database credits the endorsers when the transaction database records a successful playback of the messages. A transmission monitoring interface is preferably provided in communication with the communication service providers and the transaction database for determining when successful message playback has occurred based on information supplied by the communication service providers and for screening out partial message playback instances. The transmission monitoring interface also may preferably flags aberrant rates of message playback to identify abuse of the system, e.g., an endorser calling his own phone repeatedly to boost his playback rate.

In addition to having message creators provide single messages that are adopted one at a time by endorsers, the messages may be grouped together in one or more different ways. For example, the system may include message variables associated with the messages on the message database for combining multiple of the messages into one or more message sets. Such message variables preferably include message creator identity, message content, message playback rate, or associations with specific endorsers. These message sets or “feeds” may be creatable by the endorsers, storable on the message database, and selectable by the endorsers. That is, one endorser may create a set or feed of messages, and other endorsers may adopt that feed so as to avoid having to create their own queue of messages. In such a case where a first endorser creates a set or feed and a second endorser adopts it, the message set created by a given endorser is preferably editable only by the given endorser (of course, the subsequent endorser may create her own feed based originally on the first feed and modify it as desired). As another alternative, the message sets or feeds are creatable by the message creators, storable on the message database, and selectable by the endorsers. These could be in the form of multiple advertisements for the same company or product that would alternate on an endorser's ring-back space.

After posting a message and setting up an account, the sponsor (message creator) can choose to make the message a ‘feed’, or to duplicate the message as a feed. A feed has its own rate set by the sponsor. Once the sponsor has set up a feed, the sponsor can add additional messages to the same feed, or remove messages from the feed, as long as there always remains at least one message in the feed. Endorsers may choose to select a ‘feed’-type message instead of a regular message. If they choose a feed, they may receive the feed rate for each transmission from the feed, and they accept the fact that the message that plays from their ring-back is at the discretion of the person controlling the feed.

Endorsers can also set-up endorser feeds by compiling & editing choices from all the available feeds (or even just the queue they have), and giving it a name. The pricing for endorser feeds is preferably variable from the lowest to highest offerings in the feed.

Message sets or feeds provide several advantages over the single message model. First, endorsers can endorse whole brands or organizations that they trust. Also, endorsers can endorse feeds instead of single messages, thereby avoiding the need to visit the site frequently. Sponsors can build and sustain larger communities over time by aggregating endorsers of their feeds. Endorsers can also setup category feeds and customize feeds, by grouping criteria or feeds together as a pallette for other users to endorse: ‘the ultimate environmental activist feed’, or ‘the highest paying messages on the system feed’. These types of feeds make it extremely easy for users to choose their endorsements as a group rather than picking and choosing each message, and strengthen communities & social networks within the system.

The present invention greatly improves the ability of marketers to accomplish peer-to-peer marketing campaigns by providing a system that enables a marketer to establish a “micro-endorsement” agreement and transaction with an individual endorser in which the endorser agrees to transmit the marketer's message to the endorser's own peers and associates (i.e., the people who call the endorser). Moreover, such transmissions are executed so that they are consistent with the marketer's intent, and verifiable to a degree that compensation can be made to the individual endorser of the content for each transmission. Once the agreement has been made, the endorser assigns the marketer's message to be played audibly (or visibly) to incoming callers who attempt to contact the endorser through a communication network (e.g., a wireless, land-line, or internet telephone network). By the nature of the transmission method, the message is very likely to be heard by the incoming caller just prior to a conversation with the endorser, creating an increased likelihood of further conversation about the marketer's offering between the endorser and the incoming caller.

The inventive system of matching up marketers/sponsors/message creators with potential endorsers offers marketers several advantages over the other existing marketing methods as listed above. First, like conventional marketing, the present invention positions the marketing message adjacent to non-marketing content; however, the relevance to the receiver of the non-marketing content in the present invention is likely to be much higher than in the mass media, because most of the people calling a given person have some relationship with that person. Second, the message can be transmitted during latent time prior to the telephone conversation, namely during the time while the receiver of the message (the incoming caller) is simply waiting for the call to be connected to the endorser and for the endorser to “pick up” the phone. Therefore this requires no additional time or effort on the part of the endorser or receiver of the message in order for the message to be heard, and positions the marketer's message in latent time when the receiver is likely to be listening or otherwise paying attention (to insure that the call has been connected), and does not interrupt or interfere with the non-marketing content. Third, like other endorsement marketing, the present invention attaches an implicit endorsement to the marketer's content; however, the value of the endorsement is improved because the endorser is typically someone personally known by the receiver of the marketing message. This endorser is therefore likely to be a trusted source of non-marketing content to the receiver, and so the embedding of the marketer's message with this non-marketing content adds specific and unique value to the marketer's message. Fourth, the message itself is created by the marketer, whereby the marketer can have control over the content of the message being exchanged between the endorser and the receiver, unlike other forms of peer-to-peer marketing. Another advantage is that the transmission of the message through a communication network provides an easily verifiable record of each transmission, so that the compensation can be made only for complete transmissions of the message, to minimize waste associated with other marketing methods. Yet another advantage is that the transmission of the message through a communication network enables the messages to be targeted to specific geographic locations and to specific time frames that are most directly relevant to the message content. Still another advantage of the present invention is that the endorser can individually select the messages that are transmitted, which reduces the risk to the marketer that their message will be transmitted to a disinterested receiver. Yet a further advantage is that, with the present invention, marketers have a tool which grants them access to otherwise inaccessible and undefined social networks and to individuals who are trusted endorsers of the marketer's message within these networks. Another advantage of this invention is that the cost of individual message transmissions can be very low and still provide a cumulative benefit to the endorser who is able to place multiple transmissions per day. Furthermore, since the transmissions are preferably purchased individually (as they occur) rather than en masse, the invention provides a medium that is accessible to marketers with very limited resources. These advantages effectively qualify the present invention as a new marketing medium with a combination of characteristics that are unavailable in other media.

The inventive system also offers all participating endorsers several benefits over other marketing methods listed above. First, with the present invention, all participating endorsers have an opportunity to be compensated for their status within their own social networks. Second, the endorser has control over the choices of marketers and message content they wish to endorse, and which they choose to transmit. Third, the endorser will have an opportunity to communicate their values, tastes, and preferences through the endorsement of specific content, in much the same way that a public celebrity is able to support causes, products, and other offerings through endorsement arrangements. There is no existing marketing medium that empowers and compensates individual non-celebrity endorsement in this way and on this scale, and so these advantages effectively qualify the present invention as the first such medium. The present invention also enables the endorser to customize her ring-back space readily and easily and achieve financial remuneration in the process.

### BRIEF DESCRIPTION OF THE DRAWINGS

The advantages of the present invention will be more clearly understood through study of a preferred embodiment of the invention as shown on the accompanying drawings and further described below.

FIG. 1 is a schematic showing the general environment of an implementation of the invention.

FIG. 2 is a schematic of an embodiment of the inventive system of user interfaces, data storage, and logic modules.

FIG. 3 is a general flow chart of one aspect of the invention.

FIG. 4 is a schematic of one embodiment of a marketer interface in accordance with the present invention.

FIG. 5 is a schematic of one embodiment of a database record for a message database in accordance with the present invention.

FIG. 6 is a schematic of one embodiment of a new endorser interface in accordance with the present invention.

FIG. 7 is a schematic of one embodiment of an endorser management interface in accordance with the present invention.

FIG. 8 is a schematic of one embodiment of a database record for an endorser database in accordance with the present invention.

FIG. 9 shows an exemplary flow chart of a process on an endorsement routing interface and a transmission monitoring interface in accordance with the present invention.

FIG. 10 shows an exemplary flow chart of a process on a transmission monitoring interface in accordance with the present invention.

FIG. 11 is a schematic of one embodiment of a database record for a transaction database in accordance with the present invention.

### DETAILED DESCRIPTION OF PREFERRED EMBODIMENTS AND DRAWINGS

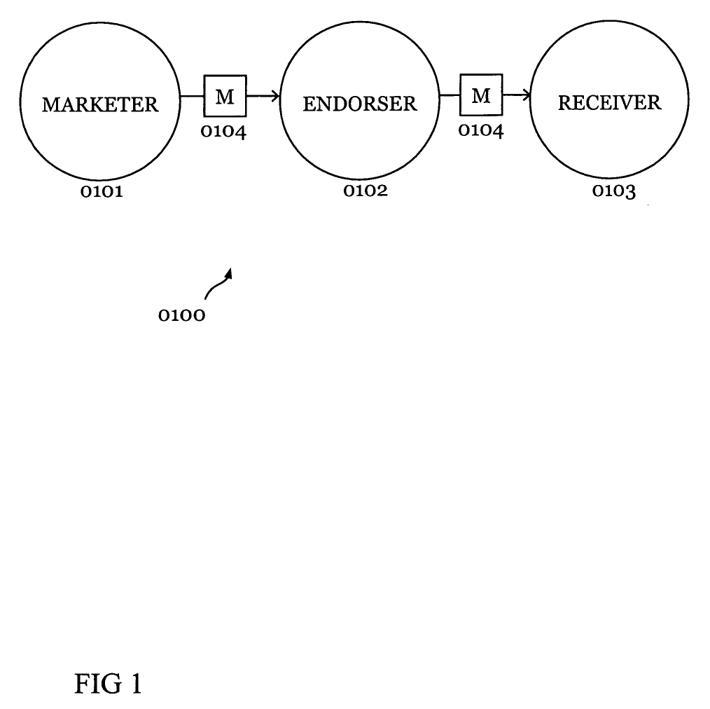

Description of the invention will now be made with reference to FIGS. 1-11. It should be noted that these drawings are exemplary in nature and in no way serve to limit the scope of the invention, which is defined by the claims appearing hereinbelow.

FIG. 1 is a diagram representing the general environment of the invention 0100 wherein a message creator such as marketer 0101 is interested in transmitting a message. The marketer 0101 presents a message object 0104 to an endorser 0102. endorser 0102 receives message object 0104 from the marketer and agrees to transmit message object 0104 to one or more receiver(s) 0103. In the general environment of the invention, message 0104 can be content of any kind. For a preferred embodiment of the invention, message object 0104 has at least one characteristic that is audible, and is a digital file in a common format (e.g., .mp3, .wav, etc.). It is also contemplated that message object 0104 includes a visual component, be it a still image (e.g., a digital file in .jpg, .bmp, or similar format) or a moving image (e.g., .avi, .wmv, mpeg, etc.).

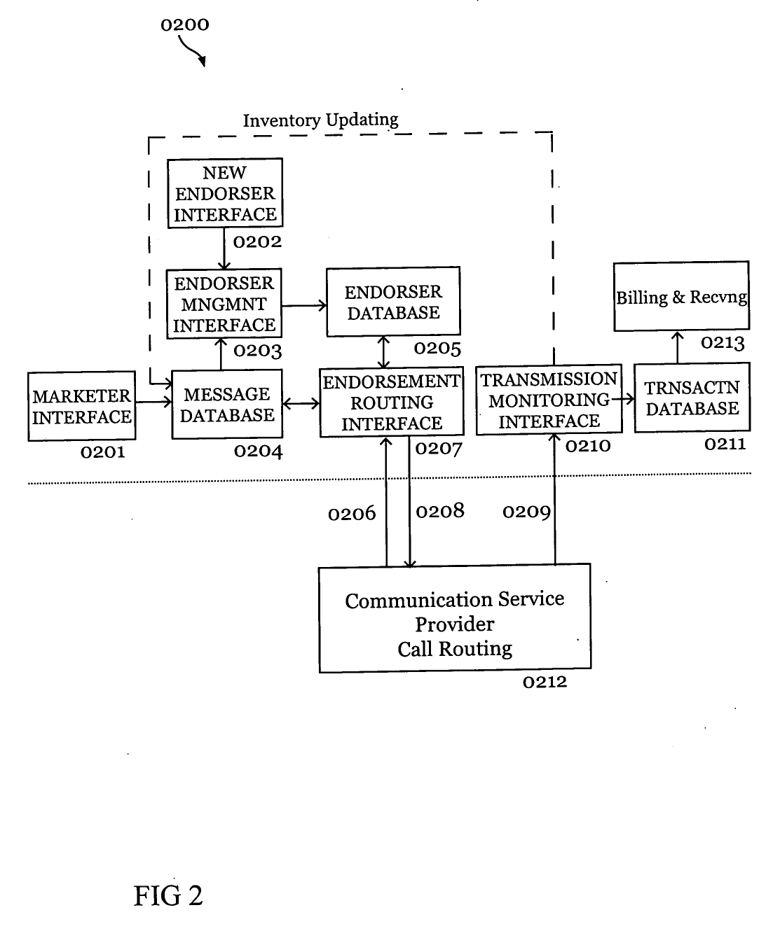

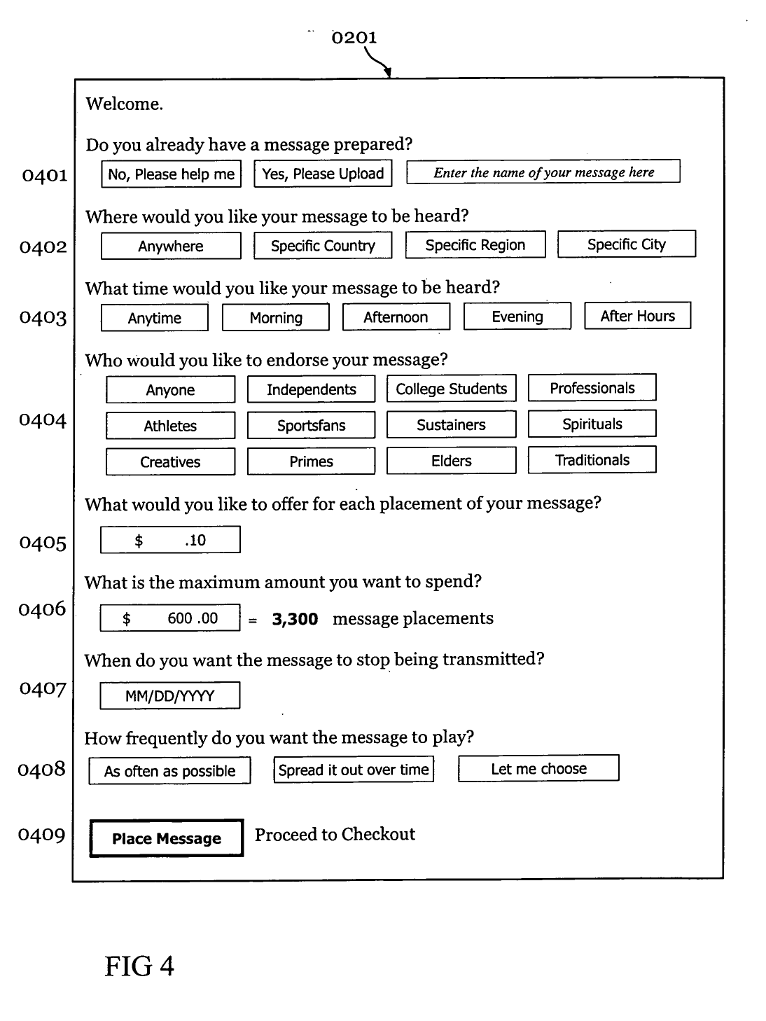

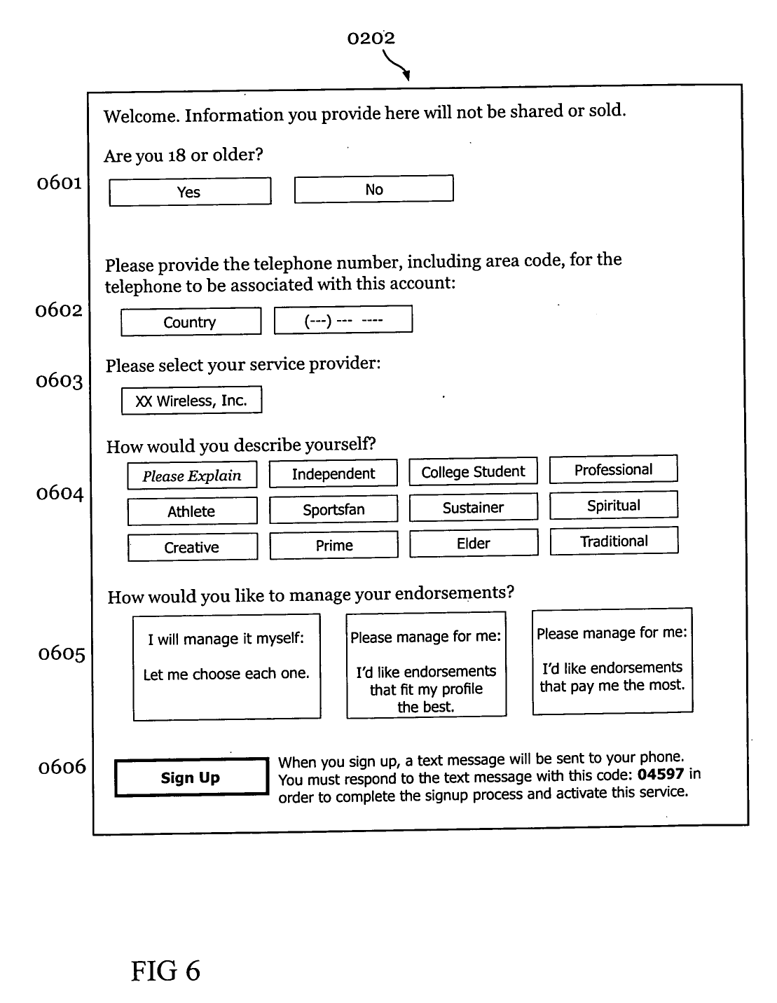

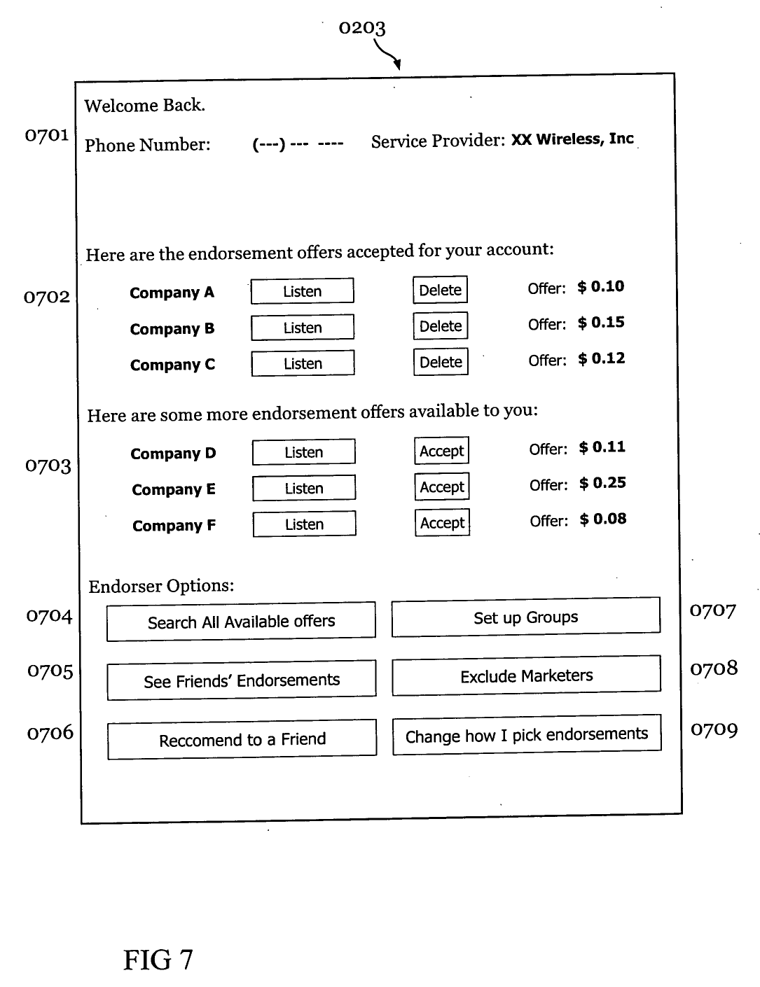

FIG. 2 depicts an embodiment of inventive system 0200, which includes several interface means and data storage means. Marketer 0101 accesses system 0200 through the marketer interface 0201 (see FIG. 4), which supplies and modifies information on message database 0204. Endorsers have access to system 0200 via two interfaces: people wishing to enroll as new endorsers access system 0200 via new endorser interface 0208 (see FIG. 6), while existing endorsers access system 0200 via endorser management interface 0203 (see FIG. 7). New endorser interface 0202 is preferably connected to endorser management interface 0203, which supplies and modifies information on the endorser database 0205. Alternatively, new endorser interface may be connected directly to endorser database 0201. Message database 0204 is provided to receive and store information from the marketer interface 0201 such as message content and variables associated with the messages. It provides information to the endorser management interface 0203 and the endorsement routing interface 0207. Endorser database 0205 receives, stores, and updates information such as the profiles of the endorsers (see below) as directed by the endorser management interface 0203. Endorsement routing interface 0207 receives content requests 0206 from communication service provider call routing 0212, evaluates content requests 0206, extracts information from message database 0204, modifies information on message database 0204, and provides transmission commands 0208 to communication service provider call routing 0212. Transmission monitoring interface 0210 receives transmission Attempt records 0209, evaluates these records, and supplies and modifies information on the transaction database 0211 and the message database 0204; and a transaction database 0211 which stores transmission records and supplies information to a conventional billing and Receiving Module 0213.

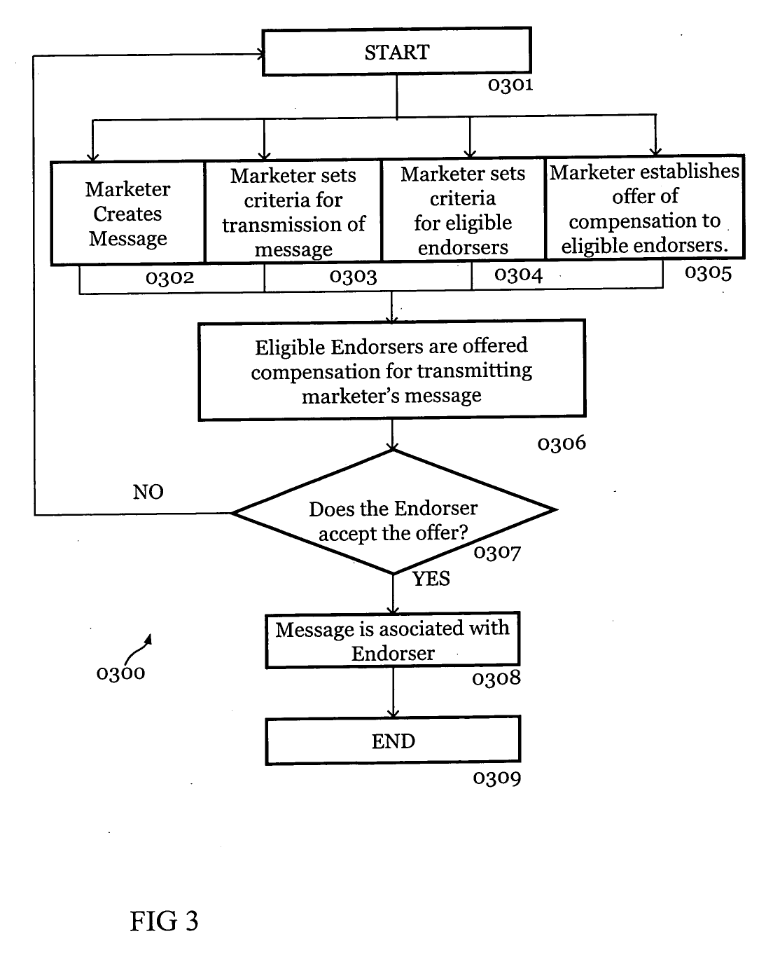

FIG. 3 is a flow chart depicting process 0300 for the matching of a message supplied by marketer 0101 with endorser 0102. In this embodiment, marketer 0101 creates a message in step 0302. Such a message is an audio/visual/text message to be played in the would-be endorser's ring-back space. Marketer 0101 sets criteria for the transmission of the message in step 0303. Such playback limiting variables or criteria include payment rate for successful playback of the message, times of day the message may be played, frequency of message playback, and the like. Marketer 0101 sets criteria for eligible endorsers in step 0304 based on any number of endorser variables that identify endorsers, such as age, location, lifestyle, or communication service provider. Marketer 0101 establishes an offer to be made to eligible endorsers, for each instance of a transmission of the message, in step 0305. Steps 0302, 0303, 0304, and 0305 can be taken in any order.

Once marketer 0101 has completed steps 0302, 0303, 0304, and 0305, the offer established by marketer 0101 is presented to endorser 0102 in step 0306. That is, an endorser logs onto system 0200 via endorser interface 0203 and selects one or more messages. In step 0307, the endorser 0102 is given the choice whether to accept the offer and endorse the message, or to reject the offer. If the offer is accepted, the message is associated with endorser 0102 in step 0308. This association is stored in a database record associated with endorser 0101 within the endorser database 0205, either as part of the endorser's profile or as a separate data file.

Process 0300 may continue, with multiple marketers making offers to multiple endorsers. Endorser 0102 may endorse multiple endorsement offers by choice, or may limit their endorsement to a single offer. For the purpose of this example, it is assumed that endorser 0102 has accepted an offer to play a specific message 0104 from marketer 0101.

FIG. 4 illustrates an embodiment of marketer interface 0201. This interface may be implemented through any means, including an internet interface such as a GUI, a voice interface, an interface within a communication device such as a telephone equipped with an internet browser, or any other means which can accommodate the display and input of this criteria. Field 0401 determines if the marketer 0101 has prepared a message, receives the message, and requests a name for the message. Field 0402 asks marketer 0101 to select criteria for the geographic placement of the message. This is effected by dint of the endorser variables in the endorser profiles. For example, a marketer may wan to limit play of a message to endorsers in a given area code. The message will only be made available to endorsers in that area code, and access will be determined by the area code variable of the endorser profile. Marketer 0101 may select multiple locations, area codes, etc. Field 0403 asks marketer 0101 to select time criteria for the placement of the message. marketer 0101 may make multiple time selections. Field 0404 asks marketer 0101 to select one or more demographic profiles for eligible endorsers. Again, these demographic subsets are determined by endorser variables in the endorser profiles. Marketer 0101 may make multiple selections. Field 0405 asks marketer 0101 to make an offer of compensation, per transmission of the message, to eligible endorsers. Field 0406 asks marketer 0101 to establish a limit of the total amount of money to be spent, including additional charges, and subsequently displays the maximum number of messages that will be placed in accordance with this limit. Field 0407 asks marketer 0101 to select a date after which any remaining messages will expire and become ineligible for transmission. Field 0408 asks the marketer to establish the frequency with which the message will be played. Field 0409 completes the marketer interface and takes the marketer to a conventional interface for a guarantee of payment. Any of fields 0401-0408 may be omitted, re-arranged, or supplemented with other fields or menus. Also, instead of presenting all of fields 0401-0409 simultaneously, multiple “pages” may be provided with one or more fields provided thereon.

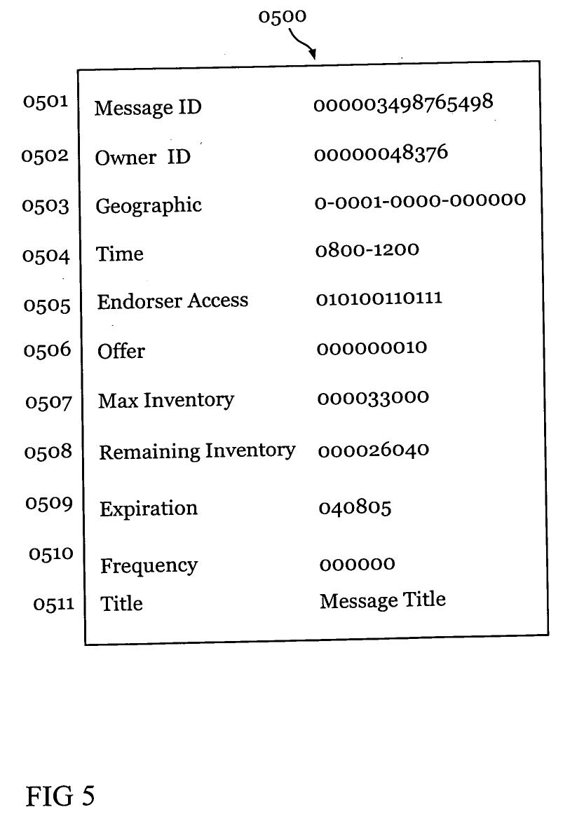

FIG. 5 is an example of a database record 0500 generated by the marketer interface 0201 and stored on message database 0204 associated with message 0104. Field 0501 is the unique message identifier. This is automatically generated and assigned to each message. Field 0502 is the owner identifier that identifies the owner/creator of the message for payment processing. For the purpose of this example, marketer 0101 is the owner identified in field 0502. Field 0503 is the geographic transmission criteria, which identifies geographic locations to which the message may be transmitted, i.e., to those endorsers whose profiles contain the qualifying geographic variables. Field 0504 is the time transmission criteria, which defines the time frame within which the message is eligible to be transmitted. Field 0505 is the endorser access, which specifies the demographic subsets of endorsers that are eligible to receive and accept the offer associated with the message. (In this example, the offer is ten cents.) Field 0506 is the offer associated with the message. Field 0507 is the maximum inventory of the message set by the total budget, the offer, and a formula that defines additional charges applied to the cost of each transmission. Field 0508 is the remaining inventory of the message, based on the max inventory 0507 minus the total sum of all messages that have been successfully transmitted. This field is updated by the endorsement Routing interface 0207 and the transmission Monitoring interface 0210. Field 0509 is the expiration date of the message, after which the remaining message will be made ineligible for transmission for the endorsers who have already adopted the message and no longer offered to endorsers who had not yet adopted the message. Field 0510 is the frequency of the message, which sets playback criteria for the number of times a message can be transmitted in a given time period, e.g., number per day or week. This number can be made to depend on the time left until expiration date 0509. Field 0511 is the message title associated with the message, to be displayed to endorser 0102 in the endorser management interface 0203.

FIG. 6 illustrates an example of one version of a new endorser interface 0202. This interface may be implemented through any means, including an internet interface such as a GUI, a voice interface, an interface within a communication device such as a telephone equipped with a web browser, or any other means which can accommodate the display and input of this criteria. Field 0601 insures that endorser 0102 is of legal age to enter into the agreement with marketer 0101. Other pre-screening data may be requested. Field 0602 asks endorser 0102 to provide the country and the phone number with which their telephone account is associated. Field 0603 asks endorser 0102 to select the communication service provider which manages the call routing for the telephone number given in step 0602. Field 0604 asks endorser 0102 to select one or more applicable demographic variables so that the endorser's profile may be appropriately categorized. Field 0605 asks endorser 0102 to select a method by which endorsements will be managed: managed exclusively by endorser 0102, managed automatically according to the demographic selection, or managed automatically according to the amount of the available offers. Other variations in endorsement management are contemplated, e.g., the enabling of endorser adoption of message sets or feeds. Feeds may be grouped by marketer, by some content variable, by price of the offer, or in other ways. Field 0606 confirms the choices, validates the sign-up process, and moves the endorser 0102 from new endorser interface 0202 to the endorsement management interface 0203.

FIG. 7 illustrates an example of one version of an endorser management interface 0203. This interface may be implemented through any means, including an internet interface such as a GUI, a voice interface, an interface within a communication device such as a telephone equipped with a web browser, or any other means which can accommodate the display and input of this criteria. Field 0701 displays the phone number and service provider associated with endorser 0102. Other information about the endorser may be displayed. Field 0702 displays the accepted endorsements and the related offers associated with endorser 0102. In Field 0702, endorser 0102 may listen to the accepted endorsements or delete the accepted endorsements. Field 0703 displays a selection of additional endorsements and the related offers available to endorser 0102. In Field 0703, endorser 0102 may listen to the offered endorsements or accept these endorsements. In this example, additional steps supplemental to the invention are illustrated as follows. Field 0704 allows endorser 0102 to search for other available offers. Field 0705 allows endorser 0102 to view offers accepted by other endorsers who have permitted endorser 0102 access to view such information. Field 0706 allows endorser 0102 to recommend an endorsement to another endorser who has permitted endorser 0102 to make such recommendations. Field 0707 allows endorser 0102 to assign specific endorsements to specific receivers 0103. Field 0708 allows endorser 0102 to exclude offers made by certain instances of marketer 0101. Field 0709 allows endorser 0102 to modify their selection made in Field 0605. A browse function of all messages or marketers, or any subsets therein, is also contemplated.

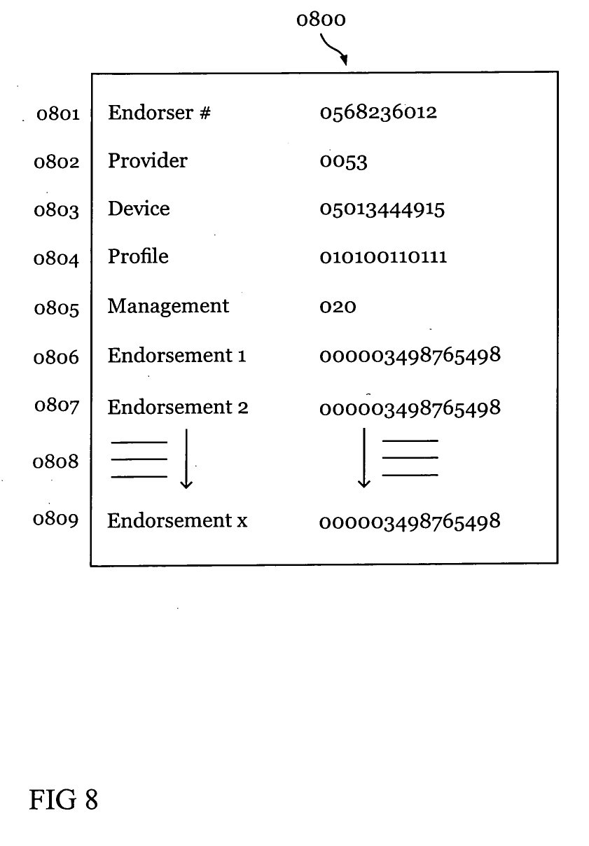

FIG. 8 illustrates a database record 0800 delineates an endorser profile storable on endorser database 0205. Field 0801 is a unique ID assigned to each endorser. Field 0802 is the service provider identifier, which identifies the service provider or network associated with the endorser's account. Field 0803 is the device identifier field which identifies the specific device associated with the endorser this may be represented by a telephone number, ESN, IMEI, or any other type of device identifier. Field 0804 describes the demographic variables selected by the endorser. Field 0805 describes the management method selected by the endorser. Field 0806 identifies a first endorsement identifier corresponding with a message database record 0500 message identifier 0501 for a message that has been endorsed by endorser 0102. Field 0807 identifies a second endorsement identifier for a second message endorsed by endorser 0102. object 0808 represents a plurality of additional fields carrying additional instances of endorsement identifiers corresponding with additional instances of message database records which have been endorsed by endorser 0102. Field 0809 represents the endorsement identifier for the final such endorsement identifier in the database record, the value for ‘x’ in the field title could be any such number as reflects a practical and manageable number of total endorsements for a single endorser. Other fields are contemplated as included in database record 0800.

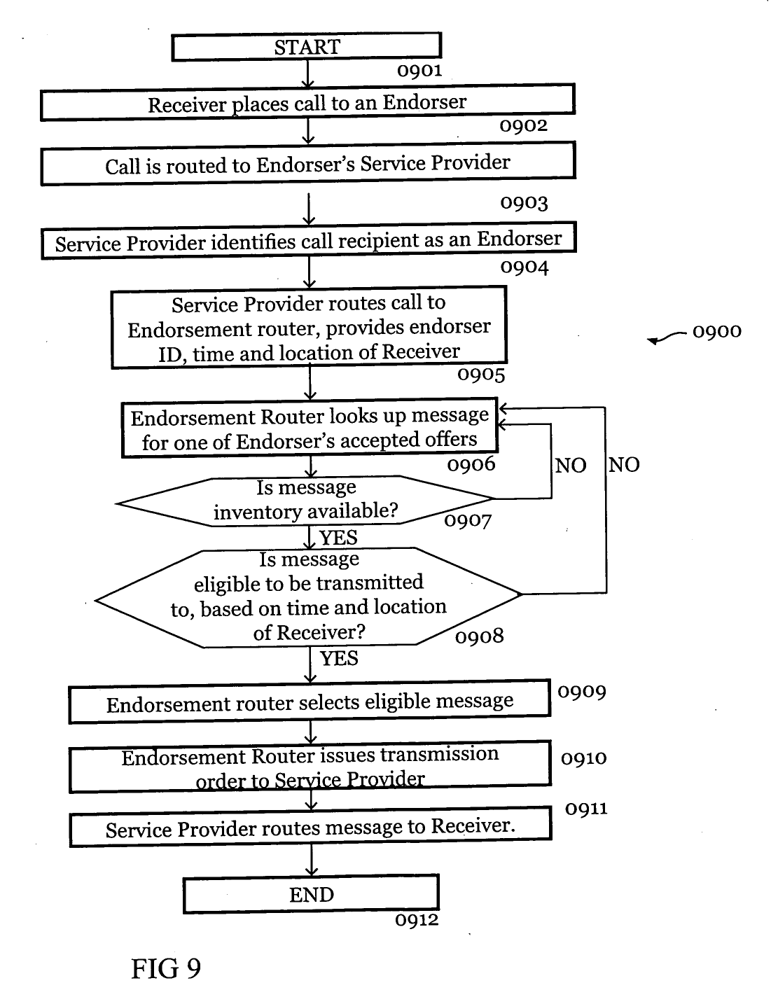

FIG. 9 represents an exemplary process 0900 on the endorsement routing interface 0207 depicting how system 0200 begins a typical transaction, i.e., how system 0200 matches a message to an endorser's ring-back space when a call is placed. In step 0902, a receiver 0103 places a telephone call to endorser 0102. In step 0903, the call is routed to the communication service provider call routing 0212 associated with endorser 0102. In step 0904, communication service provider call routing 0212 identifies the call destination as a specific device associated with an endorser 0102. In step 0905, communication service provider call routing 0212 initiates a process on the endorsement routing interface 0207, several steps of which are shown in FIG. 2. For example, step 0206 provides a data packet to the endorsement Routing interface 0207 which includes various data elements such as (but not limited to) the general location of receiver 0103, the local time at the location of receiver 0103, and the device identifier associated with the call destination.

In step 0906, the endorsement routing interface 0207 performs an operation on the endorser database 0205 to examine the endorsement identifiers 0807-0809 in the endorser profile associated with endorser 0102, and selects a message identifier from one of the fields 0807-0809 of the endorser database record 0800. For the purpose of this example, the endorsement router selects the endorsement identifier in field 0807. In step 0907, the endorsement routing interface 0207 performs a lookup operation on the message database 0204 to examine the remaining inventory of messages in field 0508 associated with the message Identifier 0501 corresponding to the selected endorsement identifier 0807. If the value of field 0508 of the message profile is greater than the value of the offer in field 0506, the message is considered available for transmission and the process moves to step 0908. If the value of field 0508 is less than the value of the offer in field 0506, the message is considered unavailable for transmission and the process returns to step 0906.

In step 0908, the endorsement Routing interface performs a lookup operation on the message database 0204 to evaluate the various playback limiting variables such as geographic transmission criteria field 0503 and the time criteria field 0504. The value of field 0503 and field 0504 is compared to the corresponding data received in step 0206 from the communication service provider call routing 0212. If the general location and the time frame of receiver 0103 (and/or other variables) are within an acceptable range defined by corresponding fields 0503 and 0504, the process moves to step 0909. If the general location and the time frame of receiver 0103 are outside of the range defined by corresponding fields 0503 and 0504, the process returns to step 0906.

In step 0909, the endorsement routing interface 0207 validates the message selection, and modifies the database record 0500 field 0508 by subtracting the value of the offer field 0506 from the value of the remaining inventory field 0508 plus any related transactional charges. In step 0910 the endorsement routing interface provides the message identifier 0501 and the associated message 0104 to the communication service provider call routing 0212 with a transmission order 0208 (see FIG. 2). Communication service provider call routing 0212 then routes the message to receiver 0103. In this embodiment of the invention, message object 0104 is routed with the transmission order. In other embodiments of the invention, message object 0104 may also reside with the system associated with the Communication Service Provider Call Routing 0212. In such cases, the endorsement Routing interface would provide the transmission Order 0208 and the message Identifier 0501 only; the message object 0104 would be routed to receiver 0103 from within the system associated with the Communication Service Provider Call Routing 0212 based on the directive included with the transmission Order 0208.

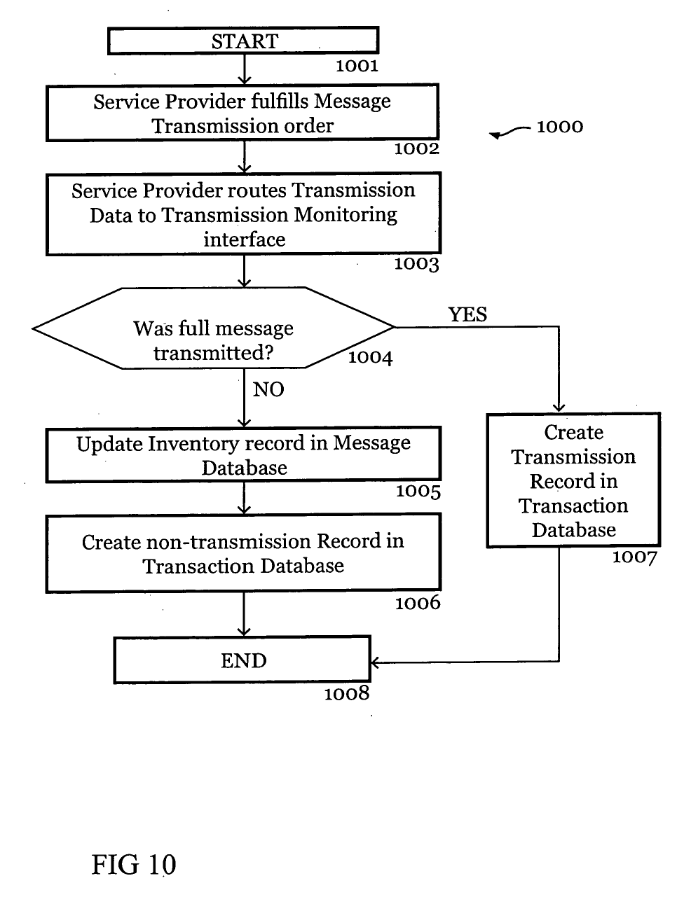

FIG. 10 represents an exemplary process 1000 on the transmission monitoring interface 0210 depicting how system 0200 completes the transaction of FIG. 9. In step 1002 the communication service provider all routing 0212 fulfills the transmission order 0208 (see FIG. 2). In step 1003, the communication service provider call routing 0212 provides transmission record data 0209 (FIG. 2) to the transmission monitoring interface 0210, which includes the duration of the message transmission. In step 1004, the transmission monitoring interface 0210 evaluates the actual duration of the message against predefined criteria for an acceptable duration of the message. If the duration value in the transmission record data 0209 satisfies the predefined criteria, the process moves to step 1007. If the duration value in the transmission record data 0209 does not satisfy the predefined criteria, the process moves to step 1005. In step 1005, the transmission monitoring interface modifies the message database record 0500 by adding the value of the offer field 0506 to the value of the Remaining Inventory field 0508, i.e., crediting the message creator the amount of the unsuccessfully transmitted message. In Step 1006, the transmission monitoring interface creates a record in the transaction database 0211 for a non-transmitted message instance. If the duration value of the transmission record data 0209 is satisfactory, then in step 1007, the transmission monitoring interface creates a record in the transaction database 0211 for a transmitted message instance.

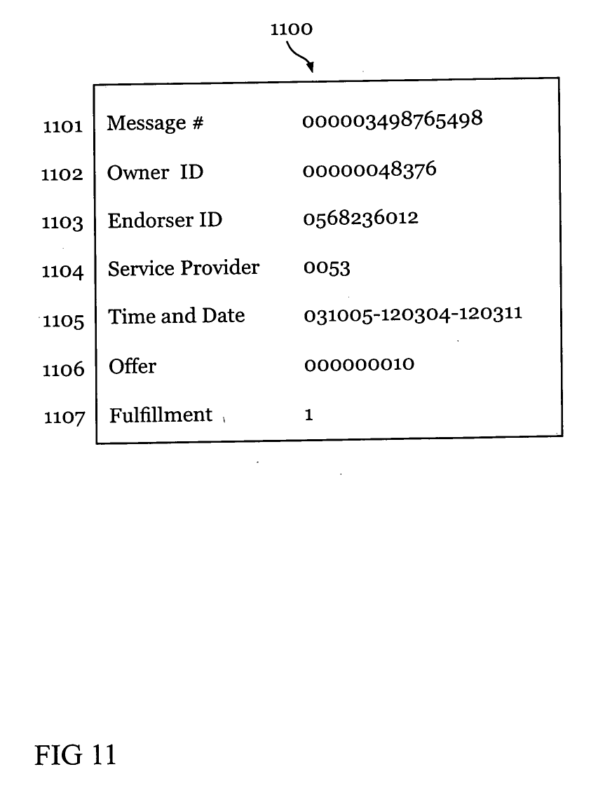

FIG. 11 represents an example of a transaction record 1100 in the transaction database 0211. Field 1101 is the message identifier associated with the message database record 0500, field 0501, for the message associated with the transmission attempt. Field 1102 is the Owner identifier associated with the message database record 0500 field 0502 for the message associated with the transmission attempt. Field 1103 is the endorser identifier associated with the endorser database record 0800 field 0801 for endorser 0102. Field 1104 is the Service Provider identifier associated with the endorser database record field 0802 for endorser 0102. Field 1105 is the time identifier for the transmission attempt, including the date of the attempt, the start time of the transmission, and the end time of the transmission. Field 1106 is the value of the offer amount corresponding to the message database record 0500 field 0506 for the message associated with the transmission attempt. Field 1107 is a value of 1 or 0 which represents the success or failure of the transmission according to the evaluation of the duration value as determined by the transmission monitoring interface 0210 in step 1004 (see FIG. 10).

Transaction record 1100 is used by billing and receiving module 0213 to reconcile accounts billable to marketer 0101 and to reconcile accounts payable to endorser 0102.

The invention is not limited to the above description or the embodiments shown in the attached exemplary drawings, but rather is defined in scope by the claims appearing hereinbelow and any and all reasonable equivalents thereof. Those skilled in the art will be able to devise other embodiments of the invention with modified or additional features not described in this embodiment, or may establish an alternate sequence of the steps described by this embodiment. One instance may include compensation to the receiver 0103; another may include compensating the communication service provider; another may include compensation to the receiver 0103 within the content of the message 0104, in the form of a coupon code or an incentive; All such variations are intended to be within the scope and the spirit of the invention, which is defined by the claims appearing below and to their reasonable equivalents as understandable by one of ordinary skill in the art. Similarly, the embodiment of the invention described above is chiefly described in terms of telephone ring-back space, however any communication device or system, either in existence now or to be developed later, is considered an appropriate venue for the invention.

What is claimed is:

1. A system of selectively providing message content in a communication system ring-back space, comprising:
a message database, accessible by one or more message creators, storing one or more messages adapted to be playable in place of a communication system ring-back tone;
an endorser database, accessible by a plurality of endorsers having telephone service, storing a plurality of endorser profiles, each of said endorser profiles including endorser-selectable variables for selecting at least one of said messages to be played in place of the respective endorsers' ring-back tone; and
an endorsement routing interface, in communication with said message database and said endorser database and also in communication with the endorsers' telecommunication service providers, routing said messages from said message database to the communication service providers for playback in place of the endorsers' ring-back tone in accordance with said endorser profiles.

2. A system of selectively providing message content in a communication system ring-back space according to claim 1, said endorser profiles further comprising endorser identification variables for placing each endorser into one or more demographic subsets of the endorsers.

3. A system of selectively providing message content in a communication system ring-back space according to claim 2, said endorser identification variables including at least one of age, location, lifestyle, or communication service provider.

4. A system of selectively providing message content in a communication system ring-back space according to claim 1, further comprising message profiles, stored on said message database, including message creator-selectable instructions for enabling playback of said messages in place of the ring-back tones of at least one of said demographic subsets of the endorsers determinable by said endorser identification variables.

5. A system of selectively providing message content in a communication system ring-back space according to claim 1, further comprising a message creator interface allowing access to said message database by the message creators.

6. A system of selectively providing message content in a communication system ring-back space according to claim 5, wherein said message creator interface comprises a web-based GUI.

7. A system of selectively providing message content in a communication system ring-back space according to claim 5, wherein said message creator interface comprises playback limiting variables for limiting the transmission of said messages.

8. A system of selectively providing message content in a communication system ring-back space according to claim 7, said playback limiting variables include at least one of maximum number of message playbacks, frequency of message playbacks, or cutoff date of message playback.

9. A system of selectively providing message content in a communication system ring-back space according to claim 1, further comprising an endorser interface allowing construction of and access to said endorser profiles by the endorsers.

10. A system of selectively providing message content in a communication system ring-back space according to claim 9, wherein said endorser interface comprises a web-based GUI.

11. A system of selectively providing message content in a communication system ring-back space according to claim 10, said endorser interface further comprising a search engine that allows the endorser to select which of said messages to play back in place of the endorser's ring-back tone.

12. A system of selectively providing message content in a communication system ring-back space according to claim 9, wherein said endorser interface further comprises a new endorser interface for allowing individuals with telephone service to enroll as endorsers.

13. A system of selectively providing message content in a communication system ring-back space according to claim 12, wherein said new endorser interface comprises a web-based GUI.

14. A system of selectively providing message content in a communication system ring-back space according to claim 1, further comprising a transaction database in communication with the communication service providers for storing information concerning the successful playback of said messages in place of the endorsers' ring-back tones.

15. A system of selectively providing message content in a communication system ring-back space according to claim 14, further comprising a billing module in communication with said transaction database for crediting the endorsers when said transaction database records a successful playback of said messages.

16. A system of selectively providing message content in a communication system ring-back space according to claim 14, further comprising a transmission monitoring interface in communication with the communication service providers and said transaction database for determining when successful message playback has occurred based on information supplied by the communication service providers.

17. A system of selectively providing message content in a communication system ring-back space according to claim 16, wherein said transmission monitoring interface screens out partial message playback instances.

18. A system of selectively providing message content in a communication system ring-back space according to claim 16, wherein said transmission monitoring interface flags aberrant rates of message playback

19. A system of selectively providing message content in a communication system ring-back space according to claim 1, wherein said messages include a visual component for playback on the screens of a caller's communication device.

20. A system of selectively providing message content in a communication system ring-back space according to claim 1, further comprising message variables associated with said messages on said message database for combining multiple of said messages into one or more message sets.

21. A system of selectively providing message content in a communication system ring-back space according to claim 20, said message variables including at least one of message creator identity, message content, message playback rate, or associations with specific endorsers.

22. A system of selectively providing message content in a communication system ring-back space according to claim 20, wherein said message sets are creatable by the endorsers, storable on said message database, and selectable by the endorsers.

23. A system of selectively providing message content in a communication system ring-back space according to claim 20, wherein said message sets are creatable by the message creators, storable on said message database, and selectable by the endorsers.

24. A system of selectively providing message content in a communication system ring-back space according to claim 22, wherein a given said message set created by a first endorser is adoptable by a second endorser.

25. A system of selectively providing message content in a communication system ring-back space according to claim 22, wherein a given said message set created by a given endorser is editable only by the given endorser.

26. A system of selectively providing message content in a communication system ring-back space according to claim 5, further comprising message variables associated with said messages on said message database for combining multiple of said messages into one or more message sets,
wherein said message sets are creatable by the message creators via said message creator interface, storable on said message database, and selectable by the endorsers.

27. A system of selectively providing message content in a communication system ring-back space according to claim 9, further comprising message variables associated with said messages on said message database for combining multiple of said messages into one or more message sets,
wherein said message sets are creatable by the endorsers via said endorser interface, storable on said message database, and selectable by the endorsers.
